(19) United States
(12) Patent Application Publication
(10) Pub. No.: US 2020/0392680 A1
(43) Pub. Date: Dec. 17, 2020

(54) DEPRESSIBLE ROAD MARKER

(71) Applicant: VALERANN LTD., Tel Aviv (IL)

(72) Inventors: Ido GLANZ, Tel Aviv (IL); Shahar BAHIRI, Tel Aviv (IL)

(21) Appl. No.: 16/767,197

(22) PCT Filed: Nov. 27, 2018
(86) PCT No.: PCT/IL2018/051293

§ 371 Date: May 27, 2020

Related U.S. Application Data
(60) Provisional application No. 62/590,699, filed on Nov. 27, 2017.

(51) Int. Cl. E01F 9/571; F21S 9/03; F21S 8/00; E01F 9/559; F21V 15/04

(52) U.S. Cl. CPC E01F 9/571; F21S 9/032; F21W 2111/02; E01F 9/559; F21V 15/04; F21S 8/032

(57) ABSTRACT

A device comprising a base receptacle configured for embedding within a cavity in a pavement, having an upper end surface, said upper end surface comprising an opening, a moveable housing comprising at least one aperture and at least one light source, said moveable housing being configured to be moveably received through said opening such that a portion of said moveable housing is normally protruding above said upper end surface and can be depressed into the base receptacle by a downward force, a resilient suspension membrane mounted to said base receptacle and extending inwardly from a perimeter of said opening, said resilient suspension membrane being configured to receive said moveable housing, and a resilient member operatively coupled to said moveable housing, wherein said resilient suspension membrane and said resilient member are configured to jointly exert an upwards biasing force which returns the moveable housing to said normally protruding position.

### CROSS REFERENCE TO RELATED APPLICATIONS

This application claims the benefit of priority of U.S. Provisional Patent Application No. 62/590,699, filed Nov. 27, 2017, the contents of which are all incorporated herein by reference in their entirety.

### FIELD OF THE INVENTION

The present invention relates to the field of markers for use in marking roadway surfaces.

### BACKGROUND

Reflective or self-illuminating raised road markers are a safety device used in marking roadways. Typically, the markers are embedded in, or otherwise secured to, the surface of the pavement, and have a portion which protrudes above the pavement. This protruding portion carries a reflector or an illuminating element sufficiently above the pavement, so that light emanating from or reflected by the marker is clearly visible to oncoming motorists. The protrusion above the pavement surface may also enhance the safety features of the marker, because a longitudinal series of such markers will cause a series of thumping vibration noises which are both heard and felt by a driver, and therefore provide a warning indication to the driver that he has strayed from the proper course.

Although such elevated markers are desirable for the above reasons, the protrusion above the pavement, if too pronounced, may cause damage to a passing vehicle's wheels, or itself be damaged when driven over. For example, in regions where ordinary winter snowfalls require periodic scraping of the highway with a snowplow, the plow blade may damage the protruding marker. In addition, the protrusion may adversely affect the stability of passing vehicles by causing unwanted deflection of wheel orientation. Accordingly, there is a variety of designs of retractable or depressible markers, which may be depressed by the passing of a vehicle wheel or the impact of snowplow blade.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided in accordance with an embodiment, a device comprising a base receptacle having an upper end surface, said upper end surface comprising an opening, said base receptacle being configured for embedding within a cavity in a pavement, a moveable housing comprising at least one aperture and at least one light source disposed internally thereof, said moveable housing being configured to be moveably received through said opening such that a portion of said moveable housing comprising said at least one aperture is normally protruding above said upper end surface and can be depressed into the base receptacle upon the application of a downward force, a resilient suspension membrane mounted to said base receptacle and extending inwardly from a perimeter of said opening, said resilient suspension membrane being configured to receive said moveable housing, and a resilient member operatively coupled to said moveable housing, wherein said resilient suspension membrane and said resilient member are configured to jointly exert an upwards biasing force which returns the moveable housing to said normally protruding position.

There is also provided, in accordance with an embodiment, a method comprising providing a device comprising a base receptacle having an upper end surface, said upper end surface comprising an opening, said base receptacle being configured for embedding within a cavity in a pavement, a moveable housing comprising at least one aperture and at least one light source disposed internally thereof, said moveable housing being configured to be moveably received through said opening such that a portion of said moveable housing comprising said at least one aperture is normally protruding above said upper end surface and can be depressed into the base receptacle upon the application of a downward force, a resilient suspension membrane mounted to said base receptacle and extending inwardly from a perimeter of said opening, said resilient suspension membrane being configured to receive said moveable housing, and a resilient member operatively coupled to said moveable housing, wherein said resilient suspension membrane and said resilient member are configured to jointly exert an upwards biasing force which returns the moveable housing to said normally protruding position; forming a cavity in a pavement configured for receiving said device such that said upper end surface is flush with an upper surface of said pavement; and embedding said device in said cavity.

In some embodiments, said resilient suspension membrane and resilient member have a combined elastic modulus of between 30 and 40 N/mm².

In some embodiments, said resilient suspension membrane comprises an annular body comprising an outer annular trough, said trough rising to an inner annular ridge.

In some embodiments, said resilient suspension membrane is further configured to provide a continuous annular sealing layer between said perimeter of said opening and a perimeter of said moveable housing.

In some embodiments, said resilient suspension membrane is configured to suppress vibrations.

In some embodiments, said resilient suspension membrane and said resilient member are each made of an elastomeric material.

In some embodiments, at least one of said resilient suspension membrane and said resilient member comprises two or more layers of different elastomeric materials.

In some embodiments, said resilient member comprises a metal spring.

In some embodiments, each of said resilient suspension membrane and resilient member is configured to withstand at least 1,000,000 compression cycles.

In some embodiments, said base receptacle is configured for embedding within a cavity in a pavement such that the upper end surface is flush with the pavement.

In some embodiments, said base receptacle comprises a removable lid defining said upper end surface, said removable lid being securable to the base receptacle.

In some embodiments, the base receptacle is made of one or more materials selected from the group consisting of: steel alloy, aluminum, polymer, reinforced polymer, rubberized metal.

In some embodiments, said upper end surface comprises a tread pattern or a textured surface simulating the friction coefficient of pavement.

In some embodiments, the moveable housing comprises at least two apertures disposed on opposing sides of the moveable housing, wherein each of said apertures has a horizontal field of view of between 75 and 150 degrees.

In some embodiments, said at least one light source comprises a plurality of light sources in various colors.

In some embodiments, the device further comprises a solar panel power source and a rechargeable battery.

In some embodiments, the device further comprises a plurality of sensors selected from the group consisting of an acoustic sensor, a magnetic sensor, a mechanical force sensor, an optical sensor, a radar device, and a lidar device. In some embodiments, said plurality of sensors are configured for detecting at least one of road vehicle speed, road vehicle size, road vehicle classification, a stopped vehicle, a road obstacle, a road blockage, a road queue, a road accident, snow formation, ice formation, temperature, rainfall, and visibility.

There is further provided, in accordance with an embodiment, a network comprising a plurality of devices spread over a plurality of roadways, wherein each of said plurality of devices comprises a base receptacle having an upper end surface, said upper end surface comprising an opening, said base receptacle being configured for embedding within a cavity in a pavement, a moveable housing comprising at least one aperture and at least one light source disposed internally thereof, said moveable housing being configured to be moveably received through said opening such that a portion of said moveable housing comprising said at least one aperture is normally protruding above said upper end surface and can be depressed into the base receptacle upon the application of a downward force, a resilient suspension membrane mounted to said base receptacle and extending inwardly from a perimeter of said opening, said resilient suspension membrane being configured to receive said moveable housing, a resilient member operatively coupled to said moveable housing, and a communication module configured to communicate with a control center, wherein said resilient suspension membrane and said resilient member are configured to jointly exert an upwards biasing force which returns the moveable housing to said normally protruding position.

In some embodiments, the communication module is configured to communicate with the control center by using a communication selected from the group consisting of: wired communication and wireless communication.

In some embodiments, each of said devices is configured for communicating to said control center data relating to at least one of a road vehicle speed, a road vehicle size, a road vehicle classification, a stopped vehicle, a road obstacle, a road blockage, a road queue, a road accident, snow formation, ice formation, temperature, rainfall, visibility, and operational state of said device.

In some embodiments, said control center is configured for controlling an operation of each of said plurality of devices.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1C illustrate a top perspective view, a top view, and a side view, respectively, of a road marker device, according to an embodiment of the present disclosure;

FIG. 1D illustrates a moveable housing, according to an embodiment of the present disclosure;

FIGS. 2A-2C illustrate a perspective view, a perspective compressed view, and a cross-sectional view, respectively, of a resilient suspension membrane, according to an embodiment of the present disclosure;

FIGS. 2D-2E illustrate a cylindrical support footing and a suspension membrane coupled to a moveable housing and a cylindrical extension, according to an embodiment of the present disclosure;

FIGS. 3A-3C illustrate certain embodiments of a resilient member, according to an embodiment of the present disclosure; and

FIGS. 4A-4C illustrate exemplary road marker device housing and a corresponding base, according to an embodiment of the present disclosure.

### DETAILED DESCRIPTION

A depressible road marker device for marking a roadway is disclosed herein. The road marker device includes a base receptacle configured to be secured within a cavity formed in a pavement or roadway surface, such that an upper surface is substantially flush with the upper surface of the pavement. A moveable housing comprising a light source internally thereof is disposed within the base receptacle and has a portion which normally protrudes above the upper surface of the receptacle. The moveable housing may comprise a housing or a cover comprising an aperture, and a light source or a reflective surface disposed internally thereof, such that it is visible through the aperture. The moveable housing is resiliently biased upwardly by one or more resilient elements disposed within the base receptacle and is depressible downwardly into the receptacle upon the incident impact of a vehicle tire or a snowplow blade applying a downward force on the moveable housing. Also provided are a resilient suspension membrane for carrying the moveable housing within the base receptacle, and an additional resilient support member, which, together with the suspension membrane, resiliently bias the moveable housing upwardly such that it normally protrudes above the upper surface of the pavement and is visible to oncoming roadway users.

The disclosed road marker device provides a durable and cost-effective solution which may be installed quickly in existing roadway surfaces; does not require a dedicated infrastructure, such as an underground power line; and is particularly well-suited for use in climates requiring frequent clearing of snow from roadways. The disclosed road marker also offers easy internal access for maintenance and repairs. The upper surface of the embedded unit advantageously may be flat and comprises a tread pattern or another textured design to simulate the grip characteristics of roadway pavement, thus providing consistent driving conditions. By being retractable into an embedded base, the disclosed design further promotes road safety, by minimizing possible obstructions and inconsistencies over the surface of the roadway, thereby also reducing tire wear, noise, and vibrations for road users.

In certain self-illuminating embodiments of the present disclosure, the moveable housing includes a self-contained light source connected to a power source within the receptacle, such as a rechargeable battery for powering the light. A solar cell may also be included for recharging the battery from available sunlight during daylight hours.

Further disclosed is a connected network of road marker devices, which may allow remote control of the operation of the networked road marker devices, and the communication of various road-use and environmental conditions data in real-time. Therefore, such network may enhance the safety, functionality, and capacity of the roads.

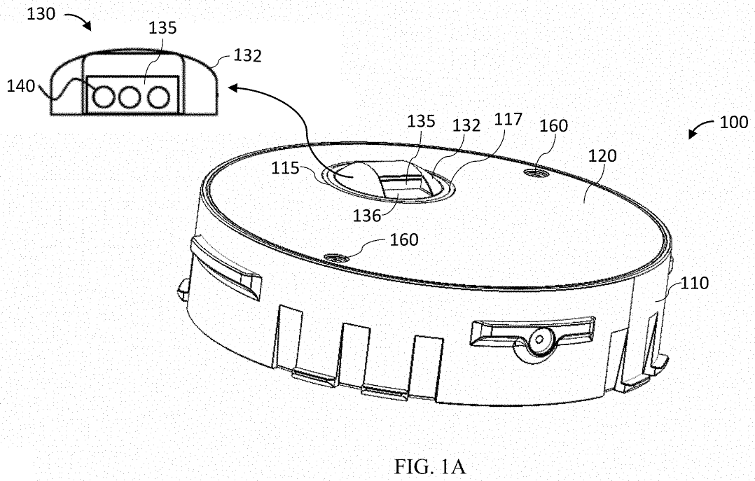

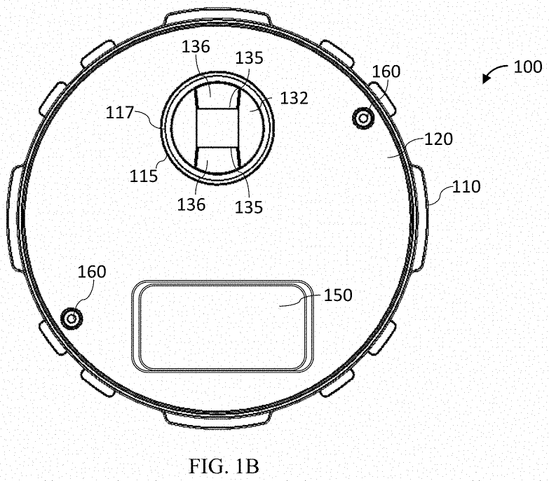

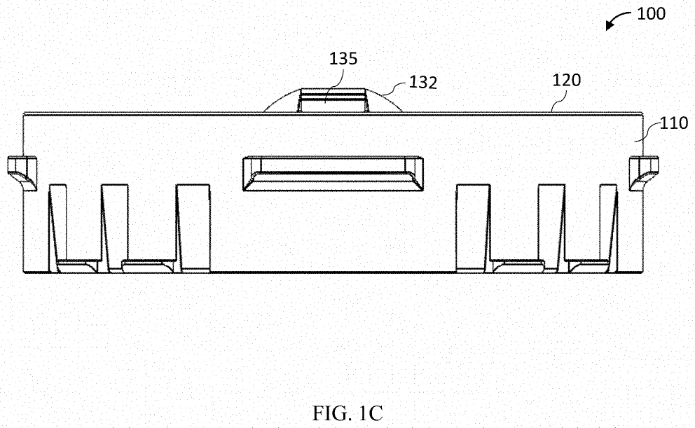

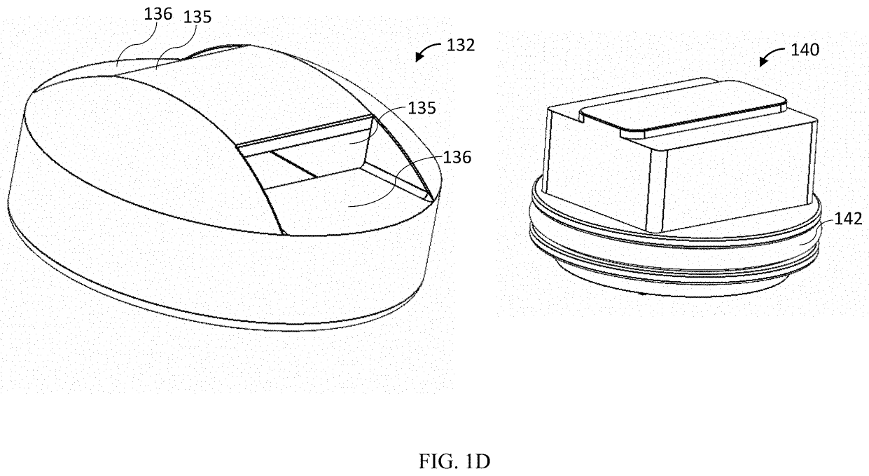

Reference is made to FIGS. 1A-1C, showing, respectively, a top perspective view, a top view, and a side view, of an exemplary embodiment of a road marker device 100. Road marker device 100 may define a cylindrical body comprising a base receptacle 110 and a lid defining a top surface 120. The base receptacle 110 may be configured to be embedded within a cavity in a pavement corresponding to the measures of the base receptacle 110, such that top surface 120 may sit no higher than the upper surface of the pavement. In some embodiments, the road marker device 100 may define an elongate, oblong, or another body shape. In some embodiments, the road marker device 100 has a height of between 40 mm and 80 mm and an upper surface area of between 350 cm² and 700 cm². In some embodiments, the base receptacle 110 and the top surface 120 are made of a steel alloy, such as stainless steel; aluminum; reinforced polymer; rubberized metal; or a combination thereof.

In some embodiments, the base receptacle 110 may be a single integrated unit. In some embodiments, the base receptacle 110 may be an assembly. For example, the base receptacle 110 may include base receptacle 110, and a lid such as top surface 120, designed to close base receptacle 110. In some embodiments, the exterior of base receptacle 110 may include one or more means for securing base receptacle 110 within a cavity in a roadway, such as resilient tabs. In some embodiments, the exterior of base receptacle 110 and/or top surface 120 may include a plurality of means to facilitate the extraction of road marker device 100 from the road, such as slits (not shown). The exterior of base receptacle 110 and/or top surface 120 may also include a plurality of fasteners, such as screws 160, for securely attaching lid 120 to base receptacle 110. By unscrewing screws 160 and removing lid/top surface 120, there is provided ready access to the interior of the road marker 100 for maintenance and repair. As noted above, in some embodiments, the top surface 120 may include a tread pattern or texture (not shown) simulating the friction characteristics of pavement, to ensure consistent driving conditions over the entire roadway.

Moveable housing 130, shown in a detailed view in FIG. 1A, is moveably disposed within an opening 115 of the top surface 110, such that a portion of moveable housing 130 protrudes above top surface 120, and, consequently, above the upper surface of the pavement. In certain embodiments, the moveable housing 130 protrudes between 5 mm and 25 mm above the upper surface 120. The moveable housing 130 comprises a cover 132 comprising one or more apertures 135. Light sources 140 may be positioned within cover 132 and illuminate through the one or more apertures 135. Cover 132 may advantageously be made of, e.g., a stainless-steel alloy.

Apertures 135 may comprise a transparent window made of, e.g., tempered glass and/or polycarbonate, to shield light sources 140 from the ambient environment. Apertures 135 are advantageously disposed within one or more recesses 136 of cover 132, to guard the apertures 135 and, by extension, light sources 140, from shattering impacts. Apertures 135 may be arranged about cover 132 to form a unidirectional, bidirectional, or multidirectional road marker device. For example, in bi-directional applications, apertures 135 may provide horizontal fields of view of between 60 and 150 degrees, e.g., 120 degrees in opposite directions. Optionally, a single aperture 135 may be panoramic (i.e., an aperture having a horizontal field of view of up to 360 degrees). The dimensions of apertures 135 may determine their field of view. The field of view may be determined by a vertical angle (i.e., a vertical field of view) and a horizontal angle (i.e., a horizontal field of view) with respect to the road. The vertical angle may be determined by the height of apertures 135 and the horizontal angle may be determined by their width. The field of view of apertures 135 may limit the area of illumination of light sources 140.

FIG. 1D provides a detailed view of the components comprising moveable housing 130, including cover 132 and light sources 140. O-ring 142 provides a peripheral seal between cover 132 and light source 140. Light source 140 may comprise a plurality of light elements, such as light emitting diodes (LED) or light bulbs disposed within. Optionally, light sources 140 may include passive light sources, such as a reflective lens or another reflector surface. It is readily appreciated that light source 140 may be colored and have an advantageous color scheme such as red on one side and green on the other side, or other colors as may be desired in the particular application.

In some embodiments, moveable housing 130 may include an upper protruding portion of cover 132 in the form of a dome, another round shape (as shown in FIGS. 1A and 1C), or otherwise a beveled or inclined shape. Such dome-shaped or beveled or inclined upper portion of cover 132 facilitates the deflection of the protruding portion of moveable housing 130 to its withdrawn position by a plow blade or a passing wheel tire. It will be appreciated that moveable housing 130 of this embodiment is only an example for such an assembly, and other configurations and shapes may also be used.

Road marker device 100 may further include a power source for providing energy to road marker device 100. The power source may be a solar panel 150 shown in FIG. 1B. It will be appreciated that illuminated markers of the past, such as those used at airports, required some type of power source, such as an underground interconnecting wiring system. This requirement, which may be suitable for relatively short road surfaces such as air strips, where power and/or regular maintenance is readily available, has not been generally accepted or adopted for general use on highways or other general road surface installations. In addition, these markers may require installation at the time of construction of the roadway because of the installation of wiring which may be necessary to institute such a system. In contrast, by comprising solar panel 150, road marker device 100 requires no dedicated underground infrastructure and can be located at any location on existing roadways.

Solar panel 150 may be covered by a transparent flat plate leveled with top surface 120. Solar panel 150 may absorb sunlight, convert it to electrical power, and transmit the power to one or more batteries which may store the energy. Solar panel 150 may be coupled with light sources 140 via an electronic circuit, to manage the activation and deactivation of the light sources 140, e.g., in response to ambient light levels or battery charge levels. The electronic circuit may also manage charging of the rechargeable battery. The electronic circuit may be sealed in a waterproof cover to prevent the penetration of moisture.

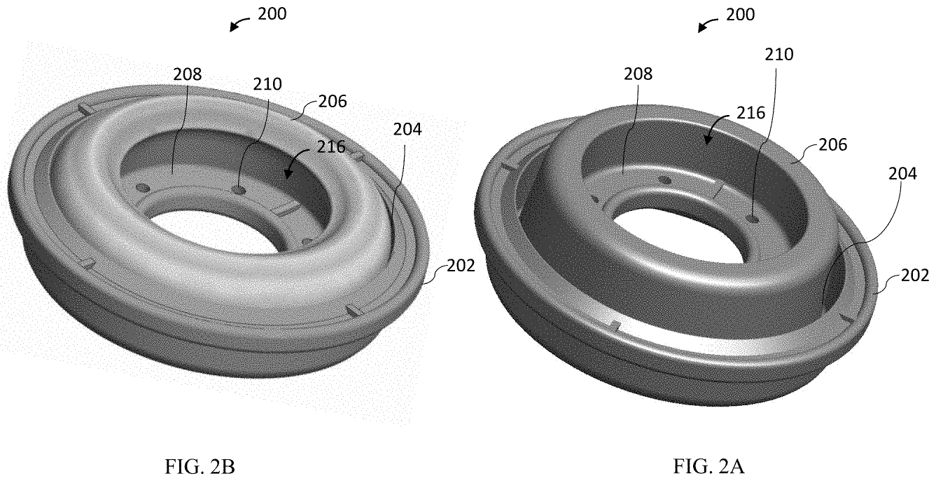

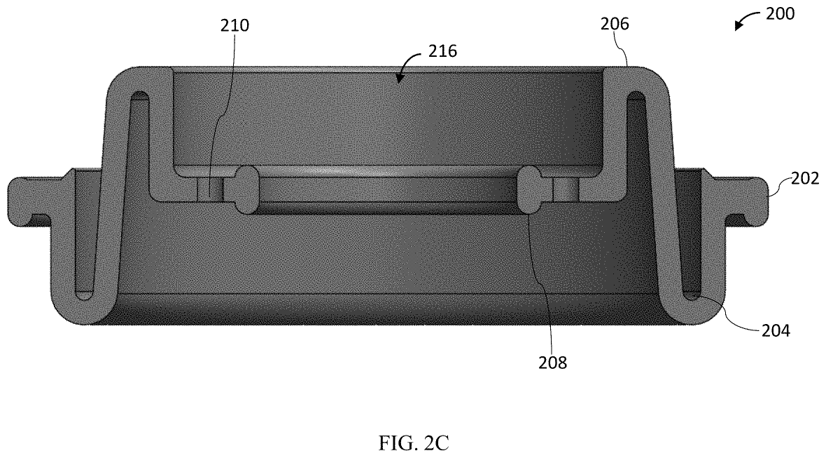

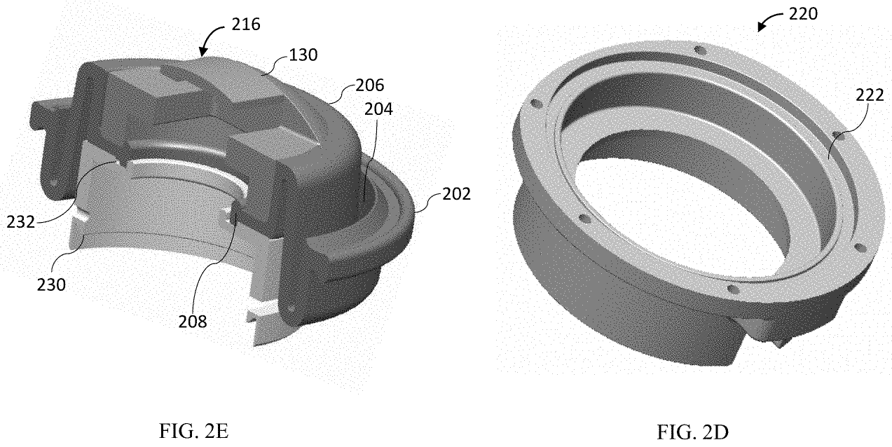

Reference is now made to FIGS. 2A-2E. FIGS. 2A, 2B and 2C show, respectively, a perspective view, a compressed or deformed view, and a cross-sectional view, of a resilient suspension membrane 200. Suspension membrane 200 is mounted within base receptacle 100 and extends inwardly from the perimeter of opening 115. Moveable housing 130 is carried within a cavity of suspension membrane 200 such that a portion of moveable housing 130 comprising at least aperture 135 is normally protruding above upper surface 120 and the surface of the pavement. Upon the application of a downward force on moveable housing 130, suspension membrane 200 deforms and compresses, as shown in FIG. 2B, thus allowing moveable housing 130 to move downwardly toward the base receptacle 130. Upon the cessation of the application of the downward force, suspension membrane 200 assumes its normal shape back, to resiliently bias moveable housing 130 upwards to its normal protruding position, while suppressing unwanted vibrations in the vertical or another dimension. Suspension membrane 200 is advantageously made of a resilient elastomeric material, such as a silicone rubber compound, which is moisture-impervious, stable, and resistant to extreme environments and temperatures. Such elastomeric material also has desirable self-sealing and vibration damping properties. Advantageously, suspension membrane 200 may comprise two or more layers of varying compounds of an elastomeric material, to provide the overall desired resiliency and vibration damping properties. For example, suspension membrane 200 may comprise a first layer of a material providing desired resiliency properties, and a second layer of a different material providing desired vibration damping properties. Alternatively, both layers may contribute by degree to both the desired resiliency and damping properties of suspension membrane 200.

It will be appreciated that, under normal use conditions in a busy roadway, the suspension membrane 200 is expected to undergo a high number of cycles of compression and expansion. Therefore, the material or combination of materials selected for, as well as the particular design profile of, suspension membrane 200, must ensure that it retains its shape and useful properties with a minimum of elongation, creep, cyclic flexing, tear, and compression set under such conditions. Advantageously, suspension membrane 200 is configured to withstand at least 1 million cycles of compression before requiring replacement.

As noted above, suspension membrane 200 is disposed about the base receptacle 110 such that it creates an annular suspension membrane extending inwardly from the rim of opening 115 of upper surface 110, for receiving the moveable housing 130 therein. Suspension membrane 200 defines an annular body having an outer diameter of between 50 mm and 100 mm, comprising an annular outer support flange 202 for engaging a corresponding groove 222 in a cylindrical footing 220 shown in FIG. 2D. Cylindrical footing 220 may be fixedly disposed within the base receptacle 110 substantially underneath the opening 115 for receiving suspension membrane 200. Advantageously, the rim and underside shoulder of opening 115 of upper surface 120 may define an annular profile which engages with the upper surface of outer support flange 202, such that outer support flange 202 is compressed between the groove 222 and the underside of the opening 115, so to create an annular seal between the ambient atmosphere and the interior of the base receptacle 110. Suspension membrane 200 further comprises an annular trough 204 adjacent outer support flange 202, said annular trough 204 rising to an annular ridge 206. The combination of the annular trough 204 and annular ridge 206 contribute to the desired resiliency and damping properties to suspension membrane 200. It will be appreciated that by employing this specific profile, or a similar profile comprising one or more troughs 204 and ridges 206, suspension membrane 202 provides for a relatively long suspension travel in the vertical dimension, within the confines of a relatively narrow annular profile. Thus, this annular profile of suspension membrane 202 works to enable the necessary downward travel of moveable housing 130 into the base receptacle 110, while limiting lateral movement of moveable housing 130, and thereby reducing the risk of damage to the suspension membrane 200 through excessive distention, stretching or elongation of the elastomeric material.

In some embodiments, suspension membrane 200 has an overall height of between 15 mm and 25 mm. Suspension membrane 200 further comprises an inner annular support flange 208, which, together with an inner wall of the ridge 206, define a cavity 216 for sealingly-receiving moveable housing 130 therein so as to form a peripheral seal around moveable housing 130. In some embodiments, cavity 216 has a diameter of between 30 mm and 40 mm and a depth of between 7 mm and 12 mm. A plurality of holes 210 facilitate fixedly securing the moveable housing 130 to an inner cylindrical extension member 230, shown in FIG. 2E, by means of a plurality of fasteners.

FIG. 2E shows in cross-section moveable housing 130 received within said cavity 216 of suspension membrane 200 and secured to cylindrical extension member 230 by means of a plurality of fasteners (not shown) passing through holes 210 of the suspension membrane 200. It will be appreciated that inner support flange 208 is being compressed between moveable housing 130 and cylindrical extension 230, so as to create an annular seal around moveable housing 130. It will be further appreciated that, as shown in FIGS. 1A and 1B, a top portion of ridge 206 of the suspension membrane creates a further annular seal 117 between the rim of opening 115 and moveable housing 130. Thus, it will be appreciated that suspension membrane 200 provides a continuous seal extending from the rim of opening 115 to the circumference of moveable housing 130, thereby whether-proofing and sealing the interior of the road marker 100 against moisture, sand, dirt, and dust from the ambient environment.

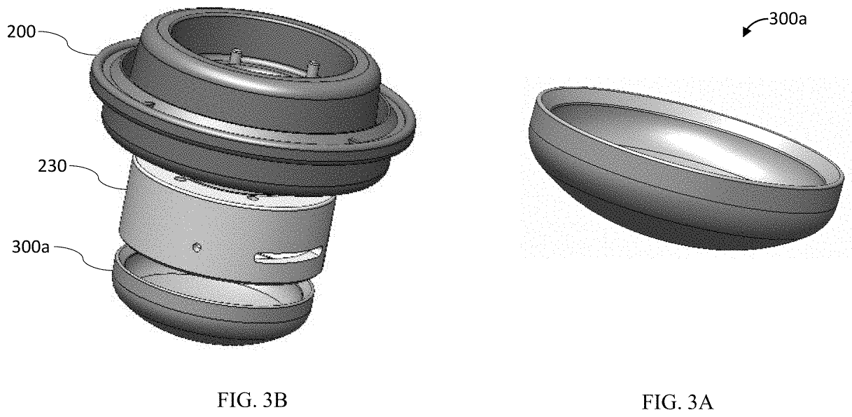

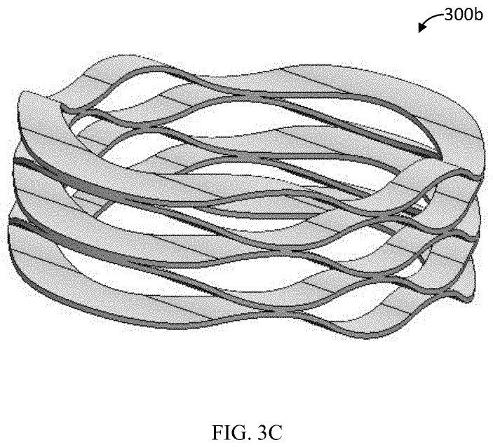

Reference is now made to FIGS. 3A-3C. In some embodiment, road marker device 100 may further include an additional resilient member 300a configured to be operatively coupled with moveable housing 130 via cylindrical extension 230. Resilient member 300a is configured to work in concert with suspension membrane 200 to provide the required amount of resiliency for biasing moveable housing 130 upwardly to its normal protruding position. Advantageously, the combined elastic modulus of suspension membrane 200 and resilient member 300a is between 30 and 40 N/mm². Resilient member 300a may define a dome or a hemisphere made of a resilient elastomeric material, such as silicone rubber. Thus, both the selection of material and the specific shape of resilient member 300a contribute to its resiliency. Resilient member 300a is disposed such that its flat surface is coupled with the underside of cylindrical extension 230, as shown in exploded view in FIG. 3B. Alternatively, various other types of resilient bodies may be provided, such as a resilient coiled wave spring or another type of spring member 300b shown in FIG. 3C. Advantageously, resilient member 300a or 300b as the case may be is configured to withstand at least 1 million cycles of compression before requiring replacement.

It will be appreciated that moveable housing 130, coupled with suspension membrane 200, cylindrical extension 230, and resilient member 300a or 300b, may form a resiliently-suspended light-source unit within road marker device 100. Such light-source unit may be readily removed for repair or replacement as a single unit by, e.g., removing lid or top surface 120 from the road marker device 100. Worn or damaged part of the light-source unit, e.g., a worn or damaged suspension membrane 200, may be further repaired or replaced by disassembling the light-source unit in the field.

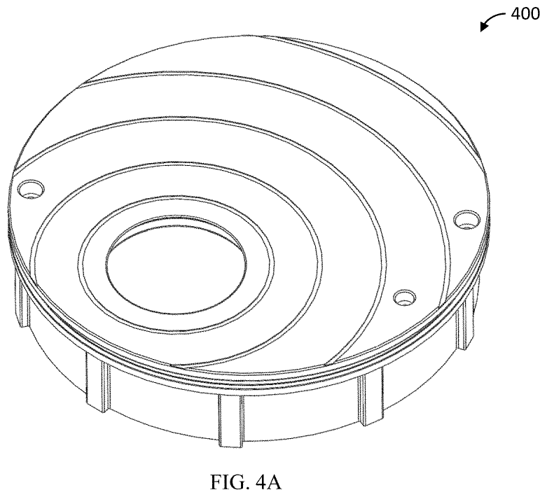

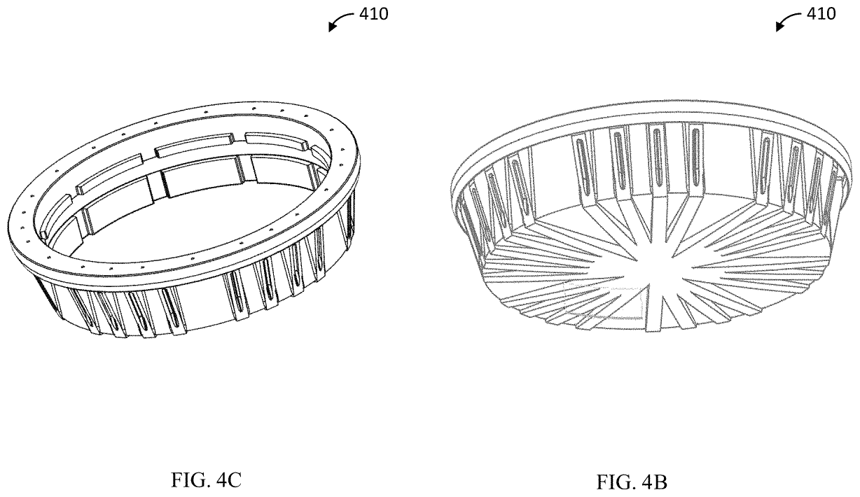

Reference is made to FIG. 4A, illustrating an exemplary embodiment of a housing 400 for a road marker, and FIGS. 4B-4C illustrating a road-embedded base 410 for housing 400. Base 410 is configured for being embedded in a cavity in pavement. In some embodiments, base 410 may be secured within the road cavity using, e.g., construction adhesive, polyurethane adhesive, concrete, and the like. Housing 400 is configured for being removably received within base 410. When needed, housing 400 may be removed form base 410, for maintenance, repair, or replacement purposes.

In some embodiments, the road marker device may include one or more sensors, gauges, radar devices, and/or similar devices, which may be configured for detecting and/or measuring data regarding road usage, road conditions, and the ambient environment. For example, the road marker device may include one or more of an acoustic sensor, a magnetic sensor, a mechanical force sensor, an optical sensor, a radar device, and/or a lidar device.

In some embodiments, a road marker of the present invention may be configured for detecting and/or measuring at least some of the count, speed, direction, size, and classification of passing vehicles. Similarly, the road marker may be configured for detecting stopped vehicles, road obstacles and blockages, queues formation, and/or road accidents in the vicinity of the marker. In some embodiments, the road marker may be further configured for detecting and/or measuring snow and ice formation on the road, ambient temperature, rainfall, and/or visibility.

In some embodiments, the road marker device may further include a communication module. The communication module may be operatively coupled with a power source, such as the solar panel. The communication module may transmit signals and/or data to a control center and/or to a service vehicle when it passes close by. Such signals and data may include technical alerts and information regarding the status of the road marker (e.g., a battery is low or the solar panel is not charging), and/or information and data gathered by the various sensors embedded in the road marker regarding road conditions, road usage, and the ambient environment. Such communication module may use a wired form of communication and/or a wireless communication, such as cellular and/or radio-based transmission.

In some embodiments, a network of multiple road marker devices, such as road marker device 100, spread over a network of roads, may be formed. Accordingly, such a network of road marker devices is further disclosed. The network may be wired and/or wireless. The control center may then remotely control the operation of the road marker devices in the network.

In some embodiments, information regarding road conditions, road usage, and the ambient environment may be gathered from a network of road markers spread over a system of roadways. Such information may be collected and processed by the control center, to, e.g., compile information about road usage and traffic conditions at a point in time or over time; identify and determine high risk areas within the road system; issue timely alerts regarding existing road and weather conditions; issue emergency alerts to emergency services regarding road accidents or stopped vehicles; and the like.

In some embodiments, the control center may be embodied as a dedicated software application, to which authorized personnel, authorities or services (e.g., governmental authorities, municipal authorities, or emergency services) may have access. The application may be executed by at least one hardware processor and may run on a stationary and/or mobile computing device (e.g., desktop computer, laptop computer, a server, a tablet or a smartphone). In some embodiments, the control center may be implemented in cloud computing and provide access through, e.g., a web-based interface.

The application may communicate with a database, which may, for example, be stored on a server in a network such as the internet. The server may include data relating to the road marker devices in the network and to the roads network (e.g., number, technical features, location and the operation status of the road marker devices and/or the location and status of the roads in the roads network). In some embodiments, the application may be configured to automatically control the operation of the road marker devices unless interrupted.

In some embodiments, the communication with the road marker devices may be unidirectional or bi-directional for controlling the operation of the road marker devices and/or receive alerts and messages from the road marker devices. For example, controlling of the operation of a road marker device may include activating or deactivating one or more light sources of the road marker device. For example, activating or deactivating one or more light sources illuminating in a specific direction (i.e., in road marker devices having more than one aperture) or in specific colors. Various colors of the light source may deliver various alerts or messages to the road users. Such alerts may increase the roads safety (e.g., when alerting of stationary traffic following an accident) and functionality (e.g., when informing of technical failures). In some embodiments the control center may communicate with the road marker to, e.g., extract operational and debugging data and metadata, and/or cause the road marker to remotely execute maintenance action. In some embodiments, a communication protocol between the control center and a road marker is configured. In some embodiments, such communications and operations are configured for minimizing any interruptions to the ongoing operation of the device.

The network may further facilitate a dynamic delineation of roads and/or lanes, including changing the position, size (i.e., length and/or width), use, priority or direction of travel of lanes and/or roads, or changing the number of lanes in a road (e.g., adding an extra lane at traffic peak hours). These may be performed by activating or deactivating specific road markers and/or specific light sources of such road marker devices and of specific colors. The activating or deactivating may be in various manners, including intermittently and in various frequencies.

In some embodiments, light source activation may be used to transmit road- and environmental-related information to passing vehicles, e.g., through light modulation and/or similar methods. The information may then be received and processed by an appropriate receiver in the vehicle.

Communication with the road marker devices network may be, for example, over a cellular network. In such embodiments, the communication module of at least a portion of the road marker devices may include a Global System for Mobile Communication (GSM) modem to facilitate communication with the control center. Alternatively, or additionally, the communication with the control center may be facilitated via GSM modems deployed separately over the roads network (i.e., not as part of the road marker device).

All of the elements described herein above in general or with respect to an embodiment of the road marker device may be combined with any other disclosed embodiments, including road marker device 100.

A method for installing and/or maintaining and/or removing a road marker device is further disclosed.

In a first step, a road marker device may be provided. The road marker device may be similar to any of the disclosed embodiments, such as road marker device 100, and to a combination thereof. In general, the road marker device may include a moveable housing having an upper surface and at least one light source configured to resiliently retract into the base receptacle 110 upon application of downward pressure.

In another step, a cavity may be formed in a road. The cavity may be dimensioned so as to receive the road marker device. The cavity may be formed in an existing paved roadway, e.g., by drilling through the paved surface. Alternatively, the cavity may be formed during construction of the roadway. In such a case, the cavity may be formed by embedding the road marker device during the pouring or forming of the pavement surface of the roadway.

In another step, the road marker device is positioned such that the upper surface of the road marker device is level with an upper surface of the pavement, such that only a portion of the light source may protrude upwards from the road marker device.

Optionally, the positioning of the road marker device inside the cavity may include positioning the road marker device such that the at least one aperture is appropriately oriented toward a desired direction of oncoming traffic. If the road marker device includes more than one aperture configured to illuminate in multiple directions, then the road marker device may be positioned in the cavity such that each aperture may face its designated direction. If the road marker device includes an aperture configured to face more than one direction, it may be positioned such that it may face all of its designated directions. For example, in a two-way road, a road marker device may be installed along the median so as to be used to guide traffic arriving from both opposing directions.

In an optional step, the road marker device may be secured within the road cavity using, e.g., construction adhesive, polyurethane adhesive, concrete, and the like.

In an optional step, a lid of the road marker device may be removed. The removing of the lid may be performed, e.g., by unfastening one or more fasteners or inserting a dedicated toll in corresponding openings in the lid. The lid may be removed for maintenance purposes or in order to remove the road marker device from the road.

A road including at least one marker device according to the disclosed embodiments or according to a combination of these embodiment is further disclosed.

The present invention may be a system, a device, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A device comprising:
a base receptacle having an upper end surface, said upper end surface comprising an opening, said base receptacle being configured for embedding within a cavity in a pavement,
a moveable housing comprising at least one aperture and at least one light source disposed internally thereof, said moveable housing being configured to be moveably received through said opening such that a portion of said moveable housing comprising said at least one aperture is normally protruding above said upper end surface and can be retracted into the base receptacle upon the application of a downward force thereto,
a resilient membrane mounted to said base receptacle and extending inwardly from a perimeter of said opening, said resilient membrane being configured to receive said moveable housing and
exert an upwards biasing force which returns the moveable housing to said normally protruding position upon cessation of the application of said downward force.

2. (canceled)

3. The device of claim 1, wherein said resilient membrane comprises an annular body having an annular profile comprising at least one annular trough and at least one annular ridge.

4. The device of claim 1, wherein said resilient membrane is further configured to provide a continuous annular sealing layer between said perimeter of said opening and a perimeter of said moveable housing.

5. The device of claim 1, wherein said resilient membrane has a narrow annular profile configured to limit lateral movement of said moveable housing within said opening.

6. The device of claim 1, wherein said resilient membrane is made of an elastomeric material.

7. The device of claim 6, wherein said resilient membrane comprises two or more layers of different elastomeric materials.

8. (canceled)

9. (canceled)

10. (canceled)

11. The device of claim 1, wherein said base receptacle comprises a removable lid defining said upper end surface, said removable lid being securable to the base receptacle.

12. The device of claim 1, wherein the base receptacle is made of one or more materials selected from the group consisting of: steel alloy, aluminum, polymer, reinforced polymer, rubberized metal.

13. The device of claim 1, wherein said upper end surface comprises a tread pattern or a textured surface simulating the friction coefficient of pavement.

14. (canceled)

15. (canceled)

16. The device of claim 1, further comprising a solar panel power source and a rechargeable battery.

17. (canceled)

18. (canceled)

19. A method comprising:
providing a device comprising:
a base receptacle having an upper end surface, said upper end surface comprising an opening, said base receptacle being configured for embedding within a cavity in a pavement,
a moveable housing comprising at least one aperture and at least one light source disposed internally thereof, said moveable housing being configured to be moveably received through said opening such that a portion of said moveable housing comprising said at least one aperture is normally protruding above said upper end surface and can be retracted into the base receptacle upon the application of a downward force thereto, and
a resilient membrane mounted to said base receptacle and extending inwardly from a perimeter of said opening, said resilient membrane being configured to receive said moveable housing and
exert an upwards biasing force which returns the moveable housing to said normally protruding position upon cessation of the application of said downward force;
forming a cavity in a pavement configured for receiving said device such that said upper end surface is flush with an upper surface of said pavement; and
embedding said device in said cavity.

20. (canceled)

21. The method of claim 19, wherein said resilient membrane comprises an annular body having an annular profile comprising at least one annular trough and at least one annular ridge.

22. The method of claim 19, wherein said resilient membrane is further configured to provide a continuous annular sealing layer between said perimeter of said opening and a perimeter of said moveable housing.

23. The method of claim 19, wherein said resilient membrane has a narrow annular profile configured to limit lateral movement of said moveable housing within said opening.

24. The method of claim 19, wherein said resilient membrane is made of an elastomeric material.

25. The method of claim 24, wherein said resilient membrane comprises two or more layers of different elastomeric materials.

26. (canceled)

27. (canceled)

28. (canceled)

29. The method of claim 19, wherein said base receptacle comprises a removable lid defining said upper end surface, said removable lid being securable to the base receptacle.

30. The method of claim 19, wherein the base receptacle is made of one or more materials selected from the group consisting of: steel alloy, aluminum, polymer, reinforced polymer, rubberized metal.

31. The method of claim 19, wherein said upper end surface comprises a tread pattern or a textured surface simulating the friction coefficient of pavement.

32. (canceled)

33. (canceled)

34. The method of claim 19, further comprising a solar panel power source and a rechargeable battery.

35. (canceled)

36. (canceled)

37. (canceled)

38. (canceled)

39. (canceled)

40. (canceled)
